(19) United States
(12) Patent Application Publication
(10) Pub. No.: US 2025/0219506 A1
(43) Pub. Date: Jul. 3, 2025

(54) SYSTEM USING COLD HEAT

(71) Applicant: NXN SYSTEMS INC., Seoul (KR)

(72) Inventor: Sang Duck CHOI, Seoul (KR)

(21) Appl. No.: 18/852,375

(22) PCT Filed: Mar. 30, 2023
(86) PCT No.: PCT/KR2023/004232

§ 371 Date: Dec. 6, 2024

(30) Foreign Application Priority Data
Mar. 30, 2022 (KR) 10-2022-0039831
Dec. 15, 2022 (KR) 10-2022-0176333

(51) Int. Cl. H02K 7/18; F17C 7/04; F28D 20/00

(52) U.S. Cl. CPC H02K 7/1823; F17C 7/04; F28D 20/00; F17C 2221/011; F17C 2221/012; F17C 2221/014; F17C 2221/033; F17C 2223/0153; F17C 2227/0355

(57) ABSTRACT

According to one aspect of the present invention, a system using cold heat is provided, comprising: a liquefied gas storage unit that stores liquefied gas; a primary loop in which a first intermediate medium receiving the cold heat of the liquefied gas circulates, and a secondary loop in which a second intermediate medium circulates, in which the second intermediate medium undergoes heat exchange with the first intermediate medium in at least one heat exchange unit interlocked with the primary loop, wherein the primary loop comprises: a first heat exchange unit for transferring the cold heat of the liquefied gas to the first intermediate medium so that 1-1 heat exchange takes place between the liquefied gas and the first intermediate medium; and a first intermediate medium storage unit which stores the first intermediate medium with which the 1-1 heat exchange has taken place, and can be converted from a closed state to an open state or from an open state to a closed state; wherein in a state in which the first intermediate medium is stored in the first intermediate medium storage unit, heat exchange is performed between the first intermediate medium and the second intermediate medium by the at least one heat exchange unit.

### FIELD OF THE INVENTION

The present invention relates to a system using cold energy.

### BACKGROUND

Liquefied gases (e.g., liquefied natural gas (LNG)) generate significant amounts of cold energy during a vaporization process, which has not been meaningfully used in an economically viable way since it is often dumped into the surrounding environment.

In recent years, as the economic value of the cold energy from the liquefied gases has been recognized, various attempts have been made to harness the cold energy, and the number of sources of demand has grown significantly.

However, techniques for utilizing the cold energy are currently being developed only regarding how to efficiently supply the cold energy to the sources of demand, but not regarding how to efficiently store the cold energy.

### SUMMARY OF THE INVENTION

One object of the present invention is to solve all the above-described problems in the prior art.

Another object of the invention is to enable cold energy from a liquefied gas to be effectively stored in a place other than a liquefied gas terminal by causing a heat exchange to occur between the liquefied gas and an intermediate medium so that the cold energy from the liquefied gas is transferred to the intermediate medium, and storing the intermediate medium in a predetermined storage unit (e.g., a tank or a balloon).

The representative configuration of the invention to achieve the above objects is described below.

According to one aspect of the invention, there is provided a system using cold energy, the system comprising: a liquefied gas storage unit configured to store a liquefied gas; a primary loop configured to circulate a first intermediate medium to which cold energy of the liquefied gas has been transferred; and a secondary loop configured to circulate a second intermediate medium for which a heat exchange with the first intermediate medium has occurred in at least one heat exchange unit interworking with the primary loop, wherein the primary loop comprises: a first heat exchange unit configured to cause the cold energy of the liquefied gas to be transferred to the first intermediate medium so that a 1-1th heat exchange occurs between the liquefied gas and the first intermediate medium; and a first intermediate medium storage unit configured to store the first intermediate medium for which the 1-1th heat exchange has occurred, and capable of being switched from a closed state to an open state or from an open state to a closed state, and wherein the at least one heat exchange unit causes a heat exchange to occur between the first intermediate medium and the second intermediate medium in a state in which the first intermediate medium is stored in the first intermediate medium storage unit.

In addition, there are further provided other methods and systems to implement the invention.

According to the invention, it is possible to enable cold energy from a liquefied gas to be effectively stored in a place other than a liquefied gas terminal by causing a heat exchange to occur between the liquefied gas and an intermediate medium so that the cold energy from the liquefied gas is transferred to the intermediate medium, and storing the intermediate medium in a predetermined storage unit (e.g., a tank or a balloon).

### BRIEF DESCRIPTION OF THE DRAWINGS

FIGS. 1 to 3 illustratively show a cold energy using system according to one embodiment of the invention.

FIG. 4 illustratively shows a cold energy using system excluding a first power generation unit according to one embodiment of the invention.

FIGS. 5 and 6 illustratively show a process of interworking a cold energy using system with a heat source according to one embodiment of the invention.

FIG. 7 illustratively shows a case where the heat source in FIG. 5 is a power generation facility.

FIG. 8 illustratively shows a case where the heat source in FIG. 6 is a power generation facility.

FIG. 9 schematically shows a cold energy using system including a secondary loop according to one embodiment of the invention.

FIGS. 10 to 18 illustratively show a secondary loop according to one embodiment of the invention.

FIGS. 19 and 20 illustratively show a cold energy using system including a secondary loop according to one embodiment of the invention.

### DESCRIPTION OF THE REFERENCE NUMERALS

10: Cold energy using system
100: Liquefied gas storage unit
200: First heat exchange unit
300: First intermediate medium storage unit
400: First power generation unit
500: First compression unit
600: Second intermediate medium storage unit
700: 2-1^{th} heat exchange unit
800: 2-1^{th} intermediate medium storage unit
900: Second power generation unit
1000: 2-2^{th} intermediate medium storage unit
1100: Second compression unit
1200: 2-2^{th} heat exchange unit
1300: 2-3^{th} heat exchange unit
1400: 2-3^{th} intermediate medium storage unit
1500: Third compression unit

### DETAILED DESCRIPTION OF THE PREFERRED EMBODIMENTS

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures and characteristics described herein may be implemented as modified from one embodiment to another without departing from the spirit and scope of the invention. Furthermore, it shall be understood that the positions or arrangements of individual elements within each embodiment may also be modified without departing from the spirit and scope of the invention. Therefore, the following detailed description is not to be taken in a limiting sense, and the scope of the invention is to be taken as encompassing the scope of the appended claims and all equivalents thereof. In the drawings, like reference numerals refer to the same or similar elements throughout the several views.

A liquefied gas as used herein refers to a gas liquefied by cooling a gas in a gaseous state at a very low temperature, and may encompass liquefied natural gas (LNG), liquefied hydrogen, liquefied nitrogen, liquefied oxygen, and the like.

Further, an intermediate medium as used herein refers to a substance that is used to transfer cold energy of a liquefied gas to a predetermined target (e.g., a heat source) or to generate electrical energy, and may encompass carbon dioxide, R125a, propane, and the like.

Furthermore, a heat source as used herein refers to a source that generates heat, and may encompass a data center (e.g., a hyperscale data center or an edge data center), power plant, steel mill, fuel cell, and the like.

Hereinafter, various preferred embodiments of the invention will be described in detail with reference to the accompanying drawings to enable those skilled in the art to easily implement the invention.

### Configuration of a Cold Energy Using System

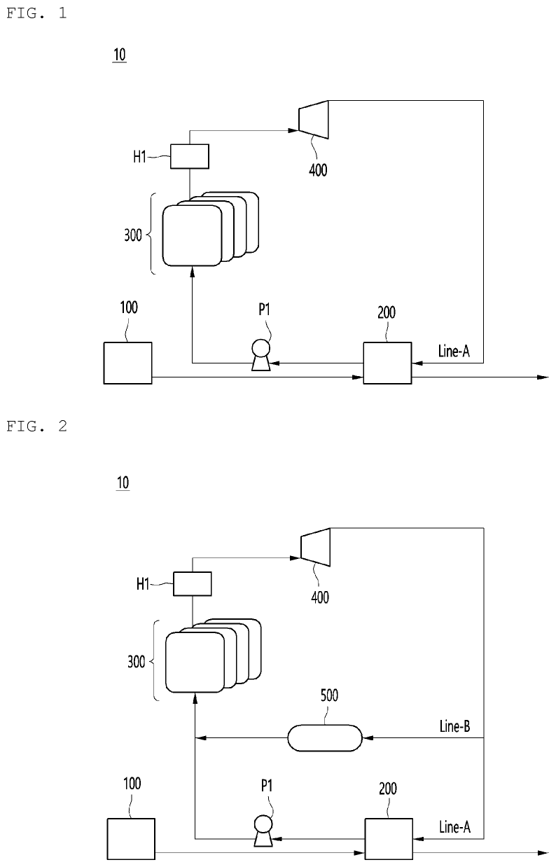

FIGS. 1 to 3 illustratively show a cold energy using system 10 according to one embodiment of the invention.

Referring to FIG. 1, the cold energy using system 10 according to one embodiment of the invention may comprise a liquefied gas storage unit 100, a first heat exchange unit 200, a first intermediate medium storage unit 300, and a first power generation unit 400.

First, the liquefied gas storage unit 100 according to one embodiment of the invention may function to store a liquefied gas.

Specifically, according to one embodiment of the invention, a liquefied gas stored at a remote location (e.g., an LNG terminal) may be transported to the liquefied gas storage unit 100 using a transportation means (e.g., a tanker truck), and the liquefied gas storage unit 100 may store the liquefied gas transported by the transportation means. Further, the liquefied gas s storage unit 100 according to one embodiment of the invention may ensure that the temperature of the liquefied gas stored therein is maintained at a constant temperature.

Next, the first heat exchange unit 200 according to one embodiment of the invention may function to cause cold energy of the liquefied gas to be transferred to an intermediate medium so that a 1-1^{th} heat exchange occurs between the liquefied gas and the intermediate medium.

Specifically, the first heat exchange unit 200 according to one embodiment of the invention may cause a 1-1^{th} heat exchange to occur between a liquefied gas supplied from the liquefied gas storage unit 100 and an intermediate medium used to generate electrical energy in the first power generation unit 400 (or an intermediate medium for which a 1-2^{th} heat exchange with a heat source H1 has occurred). Here, the first heat exchange unit 200 according to one embodiment of the invention may cause the cold energy generated by vaporization of the liquefied gas to be transferred to the intermediate medium, and cause the intermediate medium to be liquefied by absorbing the cold energy. That is, the first heat exchange unit 200 according to one embodiment of the invention may cause the 1-1^{th} heat exchange to occur between the liquefied gas and the intermediate medium so that the liquefied gas is vaporized and the intermediate medium is liquefied.

Next, the first intermediate medium storage unit 300 according to one embodiment of the invention may function to temporarily store the intermediate medium for which the 1-1^{th} heat exchange has occurred.

Specifically, according to one embodiment of the invention, the intermediate medium for which the 1-1^{th} heat exchange has occurred in the first heat exchange unit 200 (i.e., the intermediate medium in a liquid state) may be moved to the first intermediate medium storage unit 300 by operation of a pump P1, and stored inside the first intermediate medium storage unit 300.

According to one embodiment of the invention, the first intermediate medium storage unit 300 may be switched from a closed state to an open state at a first time point (e.g., when the 1-2^{th} heat exchange is required or when use of the intermediate medium is required to generate electrical energy), thereby causing the intermediate medium to move from the inside to the outside. Here, according to one embodiment of the invention, at the time when the intermediate medium moves from (or comes out of) the inside to the outside of the first intermediate medium storage unit 300, the intermediate medium may be in a liquid state or a gaseous state.

Further, according to one embodiment of the invention, the first intermediate medium storage unit 300 may be switched from the open state to the closed state at a second time point (e.g., when the 1-2^{th} heat exchange is completed or when a 1-3^{th} or 1-4^{th} heat exchange to be described later is required), thereby preventing the intermediate medium from moving from the inside to the outside.

Meanwhile, according to one embodiment of the invention, the first intermediate medium storage unit 300 may be formed in plurality. In this case, according to one embodiment of the invention, the intermediate medium may be distributed and stored in the plurality of first intermediate medium storage units 300, thereby preventing the pressure of the intermediate medium from rising excessively.

Next, the first power generation unit 400 according to one embodiment of the invention may function to generate electrical energy using the intermediate medium for which the 1-2^{th} heat exchange with the heat source H1 has occurred.

First, according to one embodiment of the invention, in response to the first intermediate medium storage unit 300 being switched to the open state, the intermediate medium may come out of the first intermediate medium storage unit 300 and move to the first power generation unit 400. According to one embodiment of the invention, the heat source H1 may be present on a path along which the intermediate medium moves from the first intermediate medium storage unit 300 to the first power generation unit 400, and the 1-2^{th} heat exchange may occur between the heat source H1 and the intermediate medium.

Here, according to one embodiment of the invention, at the time when the intermediate medium comes from the inside to the outside of the first intermediate medium storage unit 300 as described above, the intermediate medium may be in a liquid state or a gaseous state, wherein the intermediate medium in the liquid state may be vaporized by absorbing heat transferred from the heat source H1 in the 1-2^{th} heat exchange process, and the intermediate medium in the gaseous state may have an increase in temperature (i.e., remain in the gaseous state with its temperature increasing) by absorbing the heat transferred from the heat source H1 in the 1-2^{th} heat exchange process. That is, according to one embodiment of the invention, the intermediate medium that has undergone the 1-2^{th} heat exchange process may be in a gaseous state at high pressure (wherein the gaseous state may include a supercritical state).

According to one embodiment of the invention, the heat source H1 may be cooled as the 1-2^{th} heat exchange with the intermediate medium occurs, and the specific process by which the heat source H1 is cooled will be described later.

Then, the first power generation unit 400 according to one embodiment of the invention may generate electrical energy using the intermediate medium that has undergone the 1-2^{th} heat exchange process (i.e., the intermediate medium in a gaseous state at high pressure). Here, the first power generation unit 400 according to one embodiment of the invention may be a power generation facility that operates using the high-pressure gaseous intermediate medium as a working fluid, and may be at least partially similar to a conventional turbine.

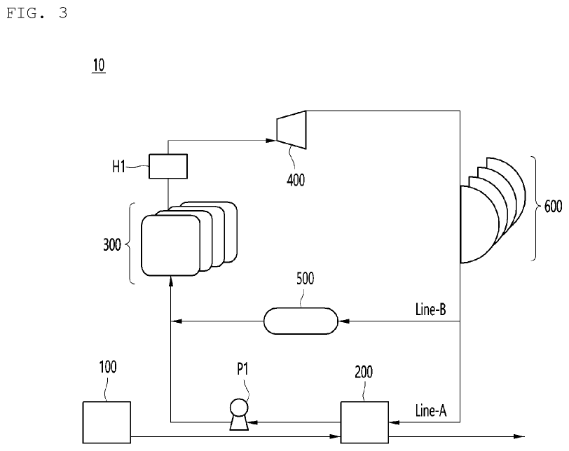

Meanwhile, referring to FIG. 2, the cold energy using system 10 according to one embodiment of the invention may further comprise a first compression unit 500.

The first compression unit 500 according to one embodiment of the invention may function to compress and liquefy the intermediate medium for which the 1-2^{th} heat exchange with the heat source H1 has occurred (or the intermediate medium used to generate electrical energy in the first power generation unit 400).

According to one embodiment of the invention, the first heat exchange unit 200 may also function to liquefy the intermediate medium for which the 1-2^{th} heat exchange with the heat source H1 has occurred (or the intermediate medium used to generate electrical energy in the first power generation unit 400), but the first heat exchange unit 200 liquefies the intermediate medium by causing cold energy of the liquefied gas to be transferred to the intermediate medium, while the first compression unit 500 liquefies the intermediate medium by compressing it.

Meanwhile, according to one embodiment of the invention, the first heat exchange unit 200 and the first compression unit 500 may be disposed on different paths. For example, for a path A (or Line-A) and a path B (or Line-B) branching from the first power generation unit 400, the first heat exchange unit 200 may be disposed on the path A (or Line-A) and the first compression unit 500 may be disposed on the path B (or Line-B). According to one embodiment of the invention, the first compression unit 500 may operate to liquefy the intermediate medium when there is insufficient cold energy to liquefy the intermediate medium in the first heat exchange unit 200, or when the cost of power to operate the first compression unit 500 is relatively low. Here, according to one embodiment of the invention, the first compression unit 500 may liquefy the intermediate medium alone in the above cases, but may also liquefy the intermediate medium in conjunction with the first heat exchange unit 200.

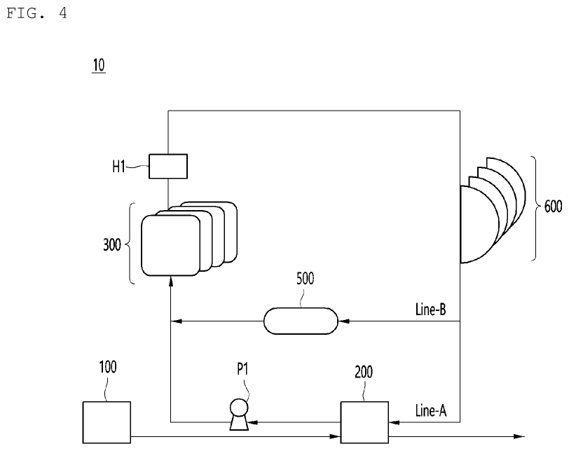

Meanwhile, referring to FIG. 3, the cold energy using system 10 according to one embodiment of the invention may further comprise a second intermediate medium storage unit 600.

The second intermediate medium storage unit 600 according to one embodiment of the invention may function to temporarily store the intermediate medium for which the 1-2^{th} heat exchange with the heat source H1 has occurred (or the intermediate medium used to generate electrical energy in the first power generation unit 400) prior to liquefaction of the intermediate medium.

Specifically, the second intermediate medium storage unit 600 according to one embodiment of the invention may temporarily store the intermediate medium for which the 1-2^{th} heat exchange has occurred (or the intermediate medium used to generate electrical energy in the first power generation unit 400) before the intermediate medium is liquefied in at least one of the first heat exchange unit 200 and the first compression unit 500.

According to one embodiment of the invention, the second intermediate medium storage unit 600 may be switched from a closed state to an open state at a predetermined time point (e.g., when the cold energy required to liquefy the intermediate medium in the first heat exchange unit 200 is available, or when the cost of power to liquefy the intermediate medium in the first compression unit 500 is not predetermined level), greater a thereby causing the intermediate medium to move from the inside to the outside. Here, according to one embodiment of the invention, at the time when the intermediate medium moves from (or comes out of) the inside to the outside of the second intermediate medium storage unit 600, the intermediate medium may be in a gaseous state.

Meanwhile, the second intermediate medium storage unit 600 according to one embodiment of the invention may be formed in a structure that can be inflated as the intermediate medium is injected (e.g., a balloon), and may be formed in plurality as necessary.

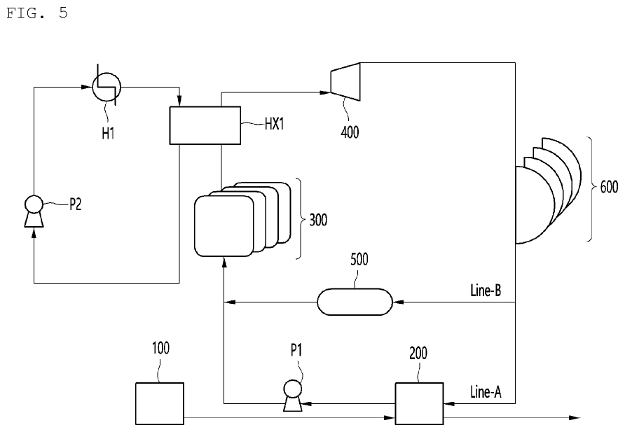

Meanwhile, although the configurations of the cold energy using system 10 according to one embodiment of the invention have been described above, there may be cases where the cold energy using system 10 may operate normally even if any of the above configurations are excluded according to one embodiment of the invention. For example, referring to FIG. 4, it may be assumed that the first power generation unit 400 according to one embodiment of the invention is excluded from the cold energy using system 10. In this case, according to one embodiment of the invention, the cold energy using system 10 may operate normally except that the process of generating electrical energy using the intermediate medium for which the 1-2^{th} heat exchange with the heat source H1 has occurred is omitted. Here, according to one embodiment of the invention, the intermediate medium for which the 1-2^{th} heat exchange with the heat source H1 has occurred may be directly stored in the second intermediate medium storage unit 600. That is, according to one embodiment of the invention, it should be understood that there may be cases where the cold energy using system 10 operates normally even if any of the configurations are excluded from the cold energy using system 10.

### First Embodiment

Hereinafter, it will be discussed in detail how to cool the heat source H1 and generate electrical energy by the cold energy using system 10 according to one embodiment of the invention.

FIG. 5 illustratively shows a process of interworking the cold energy using system 10 with the heat source H1 according to one embodiment of the invention.

Referring to FIG. 5, the cold energy using system 10 and the heat source H1 may interwork with each other using a first auxiliary heat exchange unit HX1 disposed between the first intermediate medium storage unit 300 and the first power generation unit 400, and the heat source H1 and the intermediate medium may exchange heat with each other in the first auxiliary heat exchange unit HX1 (i.e., the above-described 1-2^{th} heat exchange).

More specifically, first, the cold energy using system 10 according to one embodiment of the invention may cause the liquefied gas stored in the liquefied gas storage unit 100 and the intermediate medium used to generate electrical energy in the first power generation unit 400 (or the intermediate medium stored in the second intermediate medium storage unit 600) to move to the first heat exchange unit 200, respectively.

Then, the cold energy using system 10 according to one embodiment of the invention may cause the 1-1^{th} heat exchange to occur in the first heat exchange unit 200 between the liquefied gas and the intermediate medium. Here, according to one embodiment of the invention, cold energy generated by vaporization of the liquefied gas may be transferred to the intermediate medium, and the intermediate medium may be liquefied by absorbing the cold energy.

Then, the cold energy using system 10 according to one embodiment of the invention may cause the intermediate medium for which the 1-1^{th} heat exchange has occurred (i.e., the intermediate medium in a liquid state) to move to the first intermediate medium storage unit 300 by operation of the pump P1, and may cause the intermediate medium to be stored inside the first intermediate medium storage unit 300.

Then, the cold energy using system 10 according to one embodiment of the invention may cause the 1-2^{th} heat exchange between the heat source H1 and the intermediate medium moving from the first intermediate medium storage unit 300 to the first power generation unit 400 to occur in the first auxiliary heat exchange unit HX1. Specifically, the cold energy using system 10 according to one embodiment of the invention may cause the 1-2^{th} heat exchange to occur between a heat medium in which the heat generated by the heat source H1 is stored (e.g., water or glycol) and the intermediate medium.

Here, according to one embodiment of the invention, at the time when the intermediate medium moves from (or comes out of) the inside to the outside of the first intermediate medium storage unit 300, the intermediate medium may be in a liquid state or a gaseous state, wherein the intermediate medium in the liquid state may be vaporized by absorbing heat transferred from the heat source H1 (more specifically, the heat medium in which the heat generated by the heat source H1 is stored) in the 1-2^{th} heat exchange process, and the intermediate medium in the gaseous state may have an increase in temperature (i.e., remain in the gaseous state with its temperature increasing) by absorbing the heat transferred from the heat source H1 in the 1-2^{th} heat exchange process. That is, according to one embodiment of the invention, the intermediate medium that has undergone the 1-2^{th} heat exchange process may be in a gaseous state at high pressure (wherein the gaseous state may include a supercritical state).

Meanwhile, according to one embodiment of the invention, the heat medium may have a decrease in temperature as it undergoes the 1-2^{th} heat exchange process, and the heat medium whose temperature has decreased may cool the heat source H1. Here, according to one embodiment of the invention, circulation of the heat medium between the heat source H1 and the first auxiliary heat exchange unit HX1 may be achieved by operation of a pump P2.

Further, according to one embodiment of the invention, the heat medium in which the heat generated by the heat source H1 is stored may be temporarily stored in a thermal energy storage facility (e.g., a thermal energy storage (TES); not shown), wherein the heat medium may be moved from the thermal energy storage facility to the first auxiliary heat exchange unit HX1 at the time when the 1-2^{th} heat exchange process is initiated.

Then, the cold energy using system 10 according to one embodiment of the invention may use the intermediate medium that has undergone the 1-2^{th} heat exchange process (i.e., the intermediate medium in a gaseous state at high pressure) to generate electrical energy in the first power generation unit 400.

Then, the cold energy using system 10 according to one embodiment of the invention may cause the intermediate medium used to generate electrical energy in the first power generation unit 400 to be stored in the second intermediate medium storage unit 600.

Here, the cold energy using system 10 according to one embodiment of the invention may terminate one cycle of cooling the heat source H1 and generating electrical energy by storing the intermediate medium in the second intermediate medium storage unit 600, or may terminate the above cycle by liquefying the intermediate medium supplied from the second intermediate medium storage unit 600 in at least one of the first heat exchange unit 200 and the first compression unit 500 and storing the liquefied intermediate medium in the first intermediate medium storage unit 300.

Meanwhile, although not shown in the drawings, the cold energy using system 10 may further interwork with a compact heat source (which may be a heat source that is different from the heat source H1 and generates a relatively less amount of heat than the heat source H1) (e.g., an edge data center) using the first intermediate medium storage unit 300. Here, the cold energy using system 10 according to one embodiment of the invention may cause a heat exchange to occur between the intermediate medium and the compact heat source in a state in which the intermediate medium is stored in the first intermediate medium storage unit 300 (i.e., a state in which the first intermediate medium storage unit 300 is in a closed state). Specifically, the cold energy using system 10 according to one embodiment of the invention may cause a heat exchange to occur between a heat medium in which the heat generated by the compact heat source is stored (e.g., water or glycol) and the intermediate medium. According to one embodiment of the invention, the cold energy using system 10 may further cool the compact heat source through the above heat exchange process.

### Second Embodiment

Hereinafter, it will be discussed in detail how to cool the heat source H1 and generate electrical energy by the cold energy using system 10 according to one embodiment of the invention.

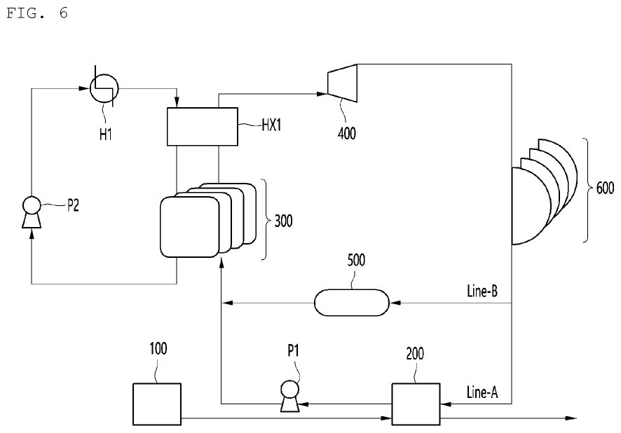

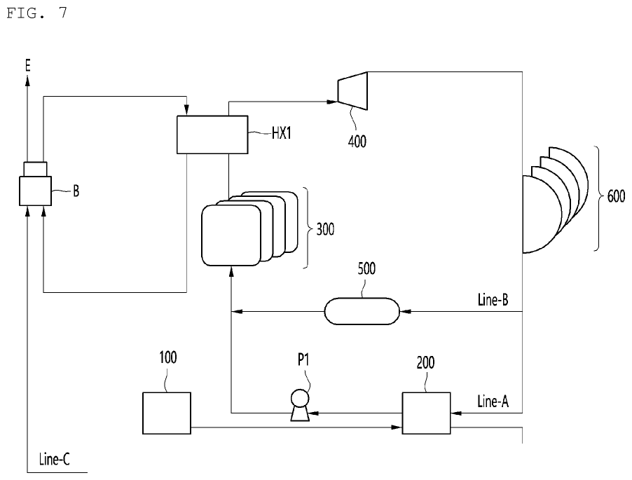

FIG. 6 illustratively shows a process of interworking the cold energy using system 10 with the heat source H1 according to one embodiment of the invention.

Referring to FIG. 6, the cold energy using system 10 and the heat source H1 may interwork with each other using the first intermediate medium storage unit 300 and the first auxiliary heat exchange unit HX1 disposed between the first intermediate medium storage unit 300 and the first power generation unit 400, and the heat source H1 and the intermediate medium may exchange heat in the first auxiliary heat exchange unit HX1 (i.e., the above-described 1-2^{th} heat exchange), and may also exchange heat in the first intermediate medium storage unit 300 (i.e., a 1-3^{th} heat exchange to be described later).

More specifically, first, the cold energy using system 10 according to one embodiment of the invention may cause the liquefied gas stored in the liquefied gas storage unit 100 and the intermediate medium used to generate electrical energy in the first power generation unit 400 (or the intermediate medium stored in the second intermediate medium storage unit 600) to move to the first heat exchange unit 200, respectively.

Then, the cold energy using system 10 according to one embodiment of the invention may cause the 1-1^{th} heat exchange to occur in the first heat exchange unit 200 between the liquefied gas and the intermediate medium. Here, according to one embodiment of the invention, cold energy generated by vaporization of the liquefied gas may be transferred to the intermediate medium, and the intermediate medium may be liquefied by absorbing the cold energy.

Then, the cold energy using system 10 according to one embodiment of the invention may cause the intermediate medium for which the 1-1^{th} heat exchange has occurred (i.e., the intermediate medium in a liquid state) to move to the first intermediate medium storage unit 300 by operation of the pump P1, and may cause the intermediate medium to be stored inside the first intermediate medium storage unit 300.

Then, the cold energy using system 10 according to one embodiment of the invention may cause a 1-3^{th} heat exchange to occur between the intermediate medium and the heat source H1 in a state in which the intermediate medium is stored in the first intermediate medium storage unit 300 (i.e., a state in which the first intermediate medium storage unit 300 is closed). Specifically, the cold energy using system according to one embodiment of the invention may cause the 1-3^{th} heat exchange to occur between a heat medium in which the heat generated by the heat source H1 is stored 10 (e.g., water or glycol) and the intermediate medium.

Here, according to one embodiment of the invention, the intermediate medium stored in the first intermediate medium storage unit 300 may be in a liquid state, and the intermediate medium may have an increase in temperature (i.e., remain in the liquid state with its temperature increasing) by absorbing the heat transferred from the heat source H1 (more specifically, the heat medium in which the heat generated by the heat source H1 is stored) in the 1-3^{th} heat exchange process.

Then, the cold energy using system 10 according to one embodiment of the invention may cause the 1-2^{th} heat exchange between the heat source H1 and the intermediate medium moving from the first intermediate medium storage unit 300 to the first power generation unit 400 (i.e., the intermediate medium that has undergone the 1-3^{th} heat exchange process) to occur in the first auxiliary heat exchange unit HX1. Specifically, the cold energy using system 10 according to one embodiment of the invention may cause the 1-2^{th} heat exchange to occur between a heat medium in which the heat generated by the heat source H1 is stored (e.g., water or glycol) and the intermediate medium, as in the 1-3^{th} heat exchange.

Here, according to one embodiment of the invention, at the time when the intermediate medium moves from (or comes out of) the inside to the outside of the first intermediate medium storage unit 300, the intermediate medium may be in a liquid state or a gaseous state, wherein the intermediate medium in the liquid state may be vaporized by absorbing heat transferred from the heat source H1 (more specifically, the heat medium in which the heat generated by the heat source H1 is stored) in the 1-2^{th} heat exchange process, and the intermediate medium in the gaseous state may have an increase in temperature (i.e., remain in the gaseous state with its temperature increasing) by absorbing heat transferred from the heat source H1 in the 1-2^{th} heat exchange process. That is, according to one embodiment of the invention, the intermediate medium that has undergone the 1-2^{th} heat exchange process may be in a gaseous state at high pressure (wherein the gaseous state may include supercritical state).

Meanwhile, according to one embodiment of the invention, the heat medium may have a decrease in temperature as it undergoes the 1-3^{th} heat exchange process and the 1-2^{th} heat exchange process, and the heat medium whose temperature has decreased may cool the heat source H1.

Here, to one according embodiment of the invention, circulation of the heat medium between the heat source H1 and the first intermediate medium storage unit 300 or the first auxiliary heat exchange unit HX1 may be achieved by operation of the pump P2.

Further, according to one embodiment of the invention, the heat medium in which the heat generated by the heat source H1 is stored may be temporarily stored in a thermal energy storage facility (e.g., a thermal energy storage (TES); not shown), wherein the heat medium may be moved from the thermal energy storage facility to the first intermediate medium storage unit 300 at the time when the 1-3^{th} heat exchange process is initiated, or may be moved from the thermal energy storage facility to the first auxiliary heat exchange unit HX1 at the time when the 1-2^{th} heat exchange process is initiated.

Then, the cold energy using system 10 according to one embodiment of the invention may use the intermediate medium that has undergone the 1-2^{th} heat exchange process (i.e., the intermediate medium in a gaseous state at high pressure) to generate electrical energy in the first power generation unit 400.

Then, the cold energy using system 10 according to one embodiment of the invention may cause the intermediate medium used to generate electrical energy in the first power generation unit 400 to be stored in the second intermediate medium storage unit 600.

Here, the cold energy using system 10 according to one embodiment of the invention may terminate one cycle of cooling the heat source H1 and generating electrical energy by storing the intermediate medium in the second intermediate medium storage unit 600, or may terminate the above cycle by liquefying the intermediate medium supplied from the second intermediate medium storage unit 600 in at least one of the first heat exchange unit 200 and the first compression unit 500 and storing the liquefied intermediate medium in the first intermediate medium storage unit 300.

### Third Embodiment

Hereinafter, it will be discussed in detail how a heat exchange (i.e., a 1-4^{th} heat exchange to be described later) occurs between the intermediate medium and an external environment at room temperature in a state in which the intermediate medium is stored in the first intermediate medium storage unit 300 according to one embodiment of the invention.

According to one embodiment of the invention, the first intermediate medium storage unit 300 may store the intermediate medium in a liquid state that has undergone the 1-1^{th} heat exchange process as described above.

The cold energy using system 10 according to one embodiment of the invention may cause a 1-4^{th} heat exchange to occur between the intermediate medium and the external environment at room temperature in a state in which the intermediate medium is stored in the first intermediate medium storage unit 300 (i.e., a state in which the first intermediate medium storage unit 300 is closed).

Here, according to one embodiment of the invention, the intermediate medium stored in the first intermediate medium storage unit 300 may be in a liquid state, and the intermediate medium may have an increase in temperature (i.e., remain in the liquid state with its temperature increasing) by absorbing heat transferred from the external environment at room temperature in the 1-4^{th} heat exchange process.

According to one embodiment of the invention, at the time when the intermediate medium moves from (or comes out of) the inside to the outside of the first intermediate medium storage unit 300 (i.e., in a state in which the first intermediate medium storage unit 300 is open), the intermediate medium may be in a liquid, gaseous, or supercritical state. Here, the cold energy using system 10 according to one embodiment of the invention may use the intermediate medium in a gaseous state (i.e., a gaseous state at high pressure) among the above states to generate electrical energy in the first power generation unit 400.

That is, the cold energy using system 10 according to one embodiment of the invention may cause the 1-4^{th} heat exchange to occur between the intermediate medium and the external environment at room temperature to generate electrical energy, even when no heat exchange (i.e., 1-2^{th} heat exchange or 1-3^{th} heat exchange) occurs between the intermediate medium and the heat source H1. However, according to one embodiment of the invention, it is apparent that the 1-4^{th} heat exchange between the intermediate medium and the external environment at room temperature does not only occur when no heat exchange (i.e., 1-2^{th} heat exchange or 1-3^{th} heat exchange) occurs between the intermediate medium and the heat source H1, but may also occur when the heat exchange (i.e., 1-2^{th} heat exchange or 1-3^{th} heat exchange) occurs between the intermediate medium and the heat source H1, as in the first or second embodiment.

### Fourth Embodiment

Hereinafter, the cases where the heat source H1 is a power generation facility B (e.g., a power plant or fuel cell) according to one embodiment of the invention will be discussed in detail.

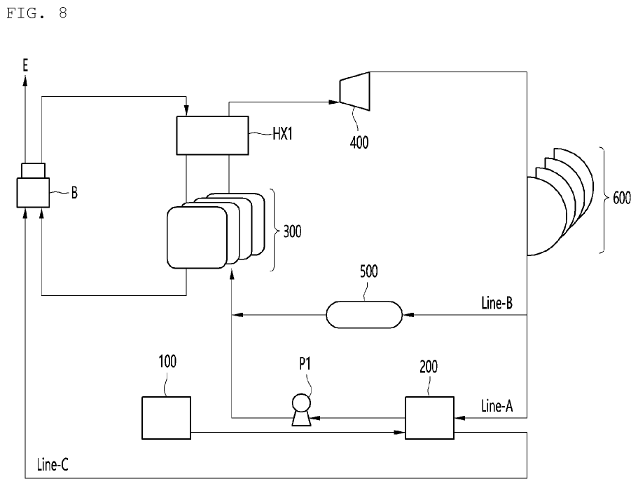

FIG. 7 illustratively shows a case where the heat source H1 in FIG. 5 is the power generation facility B, and FIG. 8 illustratively shows a case where the heat source H1 in FIG. 6 is the power generation facility B.

Referring to FIGS. 7 and 8, the cold energy using system 10 according to one embodiment of the invention may cause the 1-1^{th} heat exchange to occur between the liquefied gas and the intermediate medium in the first heat exchange unit 200. Here, the cold energy using system 10 according to one embodiment of the invention may cause the liquefied gas vaporized as the 1-1^{th} heat exchange occurs to be supplied to the power generation facility B via a path C (or Line-C). According to one embodiment of the invention, the power generation facility B may receive the liquefied gas vaporized as above via the path C (or Line-C) to generate electrical energy E.

Meanwhile, according to one embodiment of the invention, heat is generated in the process of generating electrical energy E by the power generation facility B, and the cold energy using system 10 may cause the heat generated as above to be transferred to the intermediate medium so that the 1-2^{th} or 1-3^{th} heat exchange occurs between the power generation facility B and the intermediate medium. The process of making the 1-2^{th} or 1-3^{th} heat exchange occur between the power generation facility B and the intermediate medium according to one embodiment of the invention is the same as the process of making the 1-2^{th} or 1-3^{th} heat exchange occur between the heat source H1 and the intermediate medium in the first and second embodiments, and thus a detailed description thereof will be omitted.

Meanwhile, according to one embodiment of the invention, a heat medium may be circulated between the power generation facility B and the first intermediate medium storage unit 300 or the first auxiliary heat exchange unit HX1, and the heat medium may be a flue gas discharged from the power generation facility B, or may be water, molten salt, or the like in which heat generated by the power generation facility is stored.

### Fifth Embodiment

Hereinafter, one embodiment of the invention in which the cold energy using system 10 comprises a secondary loop 10b will be discussed in detail. Meanwhile, it is noted that the cold energy using system 10 according to this embodiment may comprise the same configurations as the cold energy using system 10 previously described with reference to FIGS. 1 to 8, but some of the configurations may be omitted for ease of description.

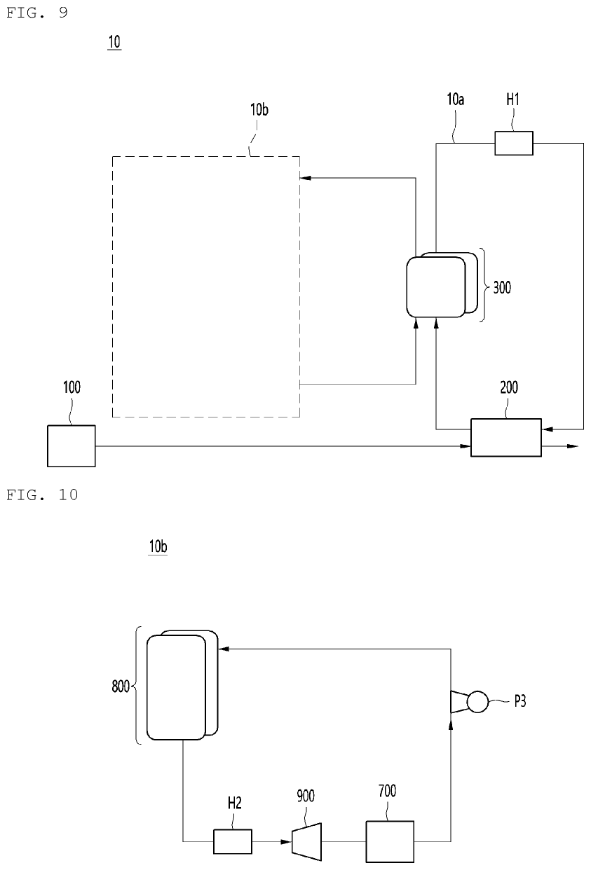

FIG. 9 schematically shows the cold energy using system 10 including the secondary loop 10b according to one embodiment of the invention.

Referring to FIG. 9, the cold energy using system 10 may include a primary loop 10a and the secondary loop 10b. Here, according to one embodiment of the invention, the primary loop 10a is a loop in which an intermediate medium (hereinafter, a “first intermediate medium”) to which cold energy of a liquefied gas is transferred circulates, and may include the same configuration as the cold energy using system 10 described with reference to FIGS. 1 to 8. For example, the primary loop 10a may include the first heat exchange unit 200 and the first intermediate medium storage unit 300. Further, according to one embodiment of the invention, the secondary loop 10b is a loop in which an intermediate medium (hereinafter, a “second intermediate medium”) which differs from the first intermediate medium circulating in the primary loop 10a circulates, and may include at least one heat exchange unit (e.g., a 2-1^{th} heat exchange unit 700, a 2-2^{th} heat exchange unit 1200, and a 2-3^{th} heat exchange unit 1300 to be described below) which interworks the secondary loop 10b with the primary loop 10a.

According to one embodiment of the invention, the at least one heat exchange unit interworking the secondary loop 10b with the primary loop 10a may cause a heat exchange (e.g., a 2-1^{th} heat exchange, a 2-3^{th} heat exchange, and a 2-4^{th} heat exchange to be described below) to occur between the first intermediate medium and the second intermediate medium. Further, the exchange may occur in a state in which the first intermediate medium is stored in the first intermediate medium storage unit 300 of the primary loop 10a.

It should be understood that sixth to fifteenth embodiments to be discussed below correspond to specific implementations of the fifth embodiment, and that what has been described with respect to the fifth embodiment may be equally applied to the sixth to fifteenth embodiments.

### Sixth Embodiment

FIG. 10 illustratively shows the secondary loop 10b according to one embodiment of the invention.

Referring to FIG. 10, the secondary loop 10b according to one embodiment of the invention may include a 2-1^{th} heat exchange unit 700, a 2-1^{th} intermediate medium storage unit 800, and a second power generation unit 900.

According to one embodiment of the invention, the 2-1^{th} heat exchange unit 700 may cause the primary loop 10a and the secondary loop 10b to interwork with each other. Specifically, the 2-1^{th} heat exchange unit 700 according to one embodiment of the invention may cause a 2-1^{th} heat exchange to occur between a first intermediate medium circulating in the primary loop 10a and a second intermediate medium circulating in the secondary loop 10b. More specifically, in a state in which the first intermediate medium for which the 1-1^{th} heat exchange has occurred in the first heat exchange unit 200 of the primary loop 10a is stored in the first intermediate medium storage unit 300, the 2-1^{th} heat exchange unit 700 according to one embodiment of the invention may cause the 2-1^{th} heat exchange to occur between the first intermediate medium and the second intermediate medium used to generate electrical energy in the second power generation unit 900 of the secondary loop 10b (which performs the same function as the first power generation unit 400 of the primary loop 10a).

According to one embodiment of the invention, the second intermediate medium (i.e., the second intermediate medium in a liquid state) for which the 2-1^{th} heat exchange has occurred in the 2-1^{th} heat exchange unit 700 may be moved to the 2-1^{th} intermediate medium storage unit 800 (which performs the same function as the first intermediate medium storage unit 300 of the primary loop 10a) by operation of a pump P3, and may be stored inside the 2-1^{th} intermediate medium storage unit 800.

According to one embodiment of the invention, the second intermediate medium may undergo a 2-2^{th} heat exchange with the heat source H2 as it moves out of the 2-1^{th} intermediate medium storage unit 800, and the second power generation unit 900 may generate electrical energy using the second intermediate medium for which the 2-2^{th} heat exchange with the heat source H2 has occurred.

### Seventh Embodiment

FIG. 11 illustratively shows the secondary loop 10b according to one embodiment of the invention.

Referring to FIG. 11, the secondary loop 10b according to one embodiment of the invention may include the 2-1^{th} heat exchange unit 700, the 2-1^{th} intermediate medium storage unit 800, the second power generation unit 900, a 2-2^{th} intermediate medium storage unit 1000, and a second compression unit 1100.

Although it has been described that the second intermediate medium used to generate electrical energy in the second power generation unit 900 of the secondary loop 10b immediately undergoes the 2-1^{th} heat exchange in the 2-1^{th} heat exchange unit 700 in the sixth embodiment, the 2-2^{th} intermediate medium storage unit 1000 and the second compression unit 1100 may be additionally disposed between the second power generation unit 900 and the 2-1^{th} heat exchange unit 700 in this embodiment.

According to one embodiment of the invention, the second intermediate medium (i.e., the second intermediate medium in a gaseous state) used to generate electrical energy in the second power generation unit 900 of the secondary loop 10b may be stored inside the 2-2^{th} intermediate medium storage unit 1000 (which performs the same function as the second intermediate medium storage unit 600 of the primary loop 10a). According to one embodiment of the invention, the second intermediate medium moving out of the 2-2^{th} intermediate medium storage unit 1000 may be liquefied while passing through the second compression unit 1100 (which may function to compress the second intermediate medium) and the 2-1^{th} heat exchange unit 700 (which may function to cause the 2-1^{th} heat exchange to occur between the second intermediate medium and the first intermediate medium). According to one embodiment of the invention, the process after the second intermediate medium has undergone the 2-1^{th} heat exchange in the 2-1^{th} heat exchange unit 700 is the same as the sixth embodiment, and thus will be omitted.

### Eighth Embodiment

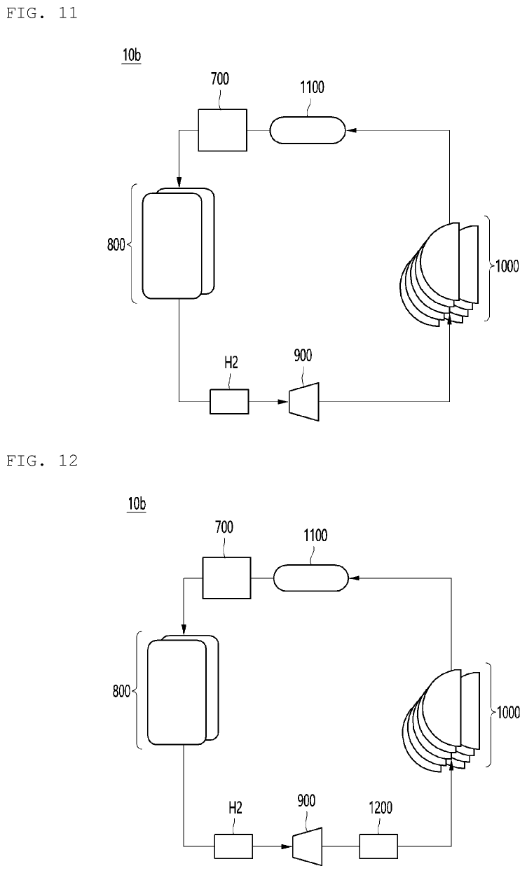

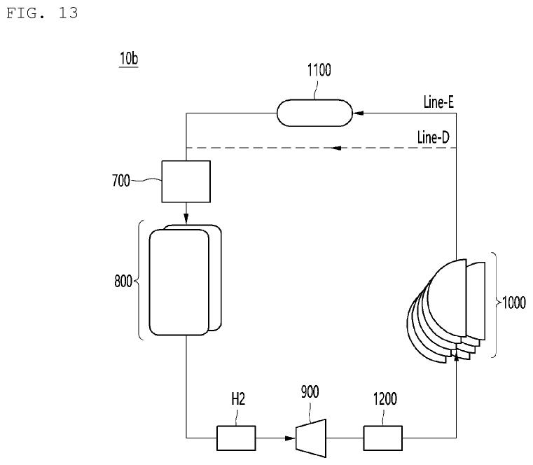

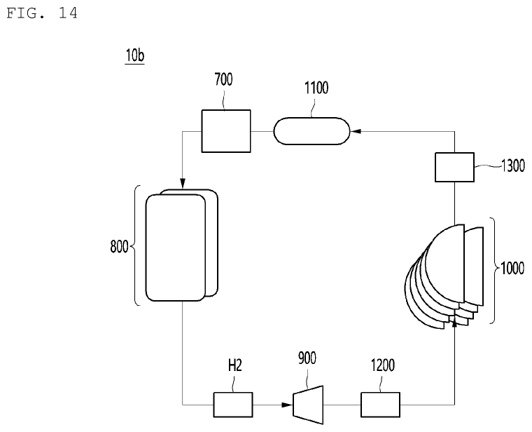

FIG. 12 illustratively shows the secondary loop 10b according to one embodiment of the invention.

Referring to FIG. 12, the secondary loop 10b according to one embodiment of the invention may include the 2-1^{th} heat exchange unit 700, the 2-1^{th} intermediate medium storage unit 800, the second power generation unit 900, the 2-2^{th} intermediate medium storage unit 1000, the second compression unit 1100, and a 2-2^{th} heat exchange unit 1200.

The secondary loop 10b in this embodiment may correspond to the secondary loop 10b in the seventh embodiment where the 2-2^{th} heat exchange unit 1200 is additionally disposed between the second power generation unit 900 and the 2-2^{th} intermediate medium storage unit 1000.

According to one embodiment of the invention, the 2-2^{th} heat exchange unit 1200 as well as the 2-1^{th} heat exchange unit 700 may cause the primary loop 10a and the secondary loop 10b to interwork with each other. Specifically, before the second intermediate medium used to generate electrical energy in the second power generation unit 900 of the secondary loop 10b is stored in the 2-2^{th} intermediate medium storage unit 1000, the 2-2^{th} heat exchange unit 1200 according to one embodiment of the invention may cause a 2-3^{th} heat exchange to occur between the second intermediate medium and the first intermediate medium. More specifically, in a state in which the first intermediate medium for which the 1-1^{th} heat exchange has occurred in the first heat exchange unit 200 of the primary loop 10a is stored in the first intermediate medium storage unit 300, the 2-2^{th} heat exchange unit 1200 according to one embodiment of the invention may cause the 2-3^{th} heat exchange to occur between the first intermediate medium and the second intermediate medium used to generate electrical energy in the second power generation unit 900 of the secondary loop 10b.

According to one embodiment of the invention, the second intermediate medium used to generate electrical energy in the second power generation unit 900 of the secondary loop 10b have a decrease in temperature and volume as it undergoes the 2-3^{th} heat exchange process, thereby maximizing the space efficiency of the 2-2^{th} intermediate medium storage unit 1000 storing the second intermediate medium. According to one embodiment of the invention, the process after the second intermediate medium has been stored in the 2-2^{th} intermediate medium storage unit 1000 is the same as the seventh embodiment, and thus will be omitted.

### Ninth Embodiment

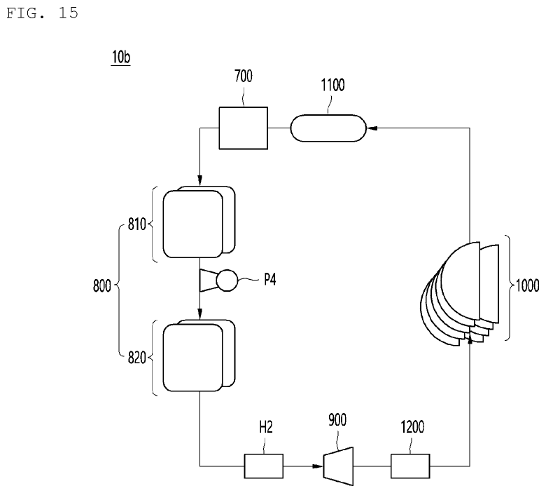

FIG. 13 illustratively shows the secondary loop 10b according to one embodiment of the invention.

Referring to FIG. 13, the secondary loop 10b according to one embodiment of the invention may include the 2-1^{th} heat exchange unit 700, the 2-1^{th} intermediate medium storage unit 800, the second power generation unit 900, the 2-2^{th} intermediate medium storage unit 1000, the second compression unit 1100, and the 2-2^{th} heat exchange unit 1200.

The secondary loop 10b in this embodiment includes the same components as the secondary loop 10b in the eighth embodiment, but may further include a bypass (or Line-D). According to one embodiment of the invention, the bypass (or Line-D) may be a path different from a path (or Line-E) in which the second compression unit 1100 is disposed, and may be formed in parallel with the path (or Line-E). According to one embodiment of the invention, the second intermediate medium moving out of the 2-2^{th} intermediate medium storage unit 1000 may be moved via the bypass (or Line-D) rather than the path (or Line-E) in which the second compression unit 1100 is disposed, when a predetermined condition is satisfied (e.g., when there is a load fluctuation in the cold energy available to the 2-1^{th} heat exchange unit 700, or when the second compression unit 1100 is operated in hours in which the cost of electric power to operate the second compression unit 1100 is relatively high). That is, according to one embodiment of the invention, the second intermediate medium moving via the bypass (or Line-D) may be liquefied while passing through the 2-1^{th} heat exchange unit 700 without passing through the second compression unit 1100 (the 2-1^{th} heat exchange unit 700 may cause the 2-1^{th} heat exchange to occur between the second intermediate medium and the first intermediate medium). According to one embodiment of the invention, the process after the second intermediate medium has undergone the 2-1^{th} heat exchange in the 2-1^{th} heat exchange unit 700 is the same as the eighth embodiment, and thus will be omitted.

### Tenth Embodiment

FIG. 14 illustratively shows the secondary loop 10b according to one embodiment of the invention.

Referring to FIG. 14, the secondary loop 10b according to one embodiment of the invention may include the 2-1^{th} heat exchange unit 700, the 2-1^{th} intermediate medium storage unit 800, the second power generation unit 900, the 2-2^{th} intermediate medium storage unit 1000, the second compression unit 1100, the 2-2^{th} heat exchange unit 1200, and a 2-3^{th} heat exchange unit 1300.

The secondary loop 10b in this embodiment may correspond to the secondary loop 10b in the eighth embodiment where the 2-3^{th} heat exchange unit 1300 is additionally disposed between the 2-2^{th} intermediate medium storage unit 1000 and the second compression unit 1100.

According to one embodiment of the invention, the 2-3^{th} heat exchange unit 1300 as well as the 2-1^{th} heat exchange unit 700 and the 2-2^{th} heat exchange unit 1200 may cause the primary loop 10a and the secondary loop 10b to interwork with each other. Specifically, before the second intermediate medium is compressed in the second compression unit 1100, the 2-3^{th} heat exchange unit 1300 according to one embodiment of the invention may cause a 2-4^{th} heat exchange to occur between the second intermediate medium and the first intermediate medium. More specifically, in a state in which the first intermediate medium for which the 1-1^{th} heat exchange has occurred in the first heat exchange unit 200 of the primary loop 10a is stored in the first intermediate medium storage unit 300, the 2-3^{th} heat exchange unit 1300 according to one embodiment of the invention may cause the 2-4^{th} heat exchange to occur between the first intermediate medium and the second intermediate medium moving from the 2-2^{th} intermediate medium storage unit 1000 to the second compression unit 1100.

According to one embodiment of the invention, the second intermediate medium moving from the 2-2^{th} intermediate medium storage unit 1000 to the second compression unit 1100 may have a decrease in temperature and volume as it undergoes the 2-4^{th} heat exchange process, thereby minimizing heat loss during the process of compressing the second intermediate medium in the second compression unit 1100. According to one embodiment of the invention, the process after the second intermediate medium has been compressed in the second compression unit 1100 is the same as the eighth embodiment, and thus will be omitted.

### Eleventh Embodiment

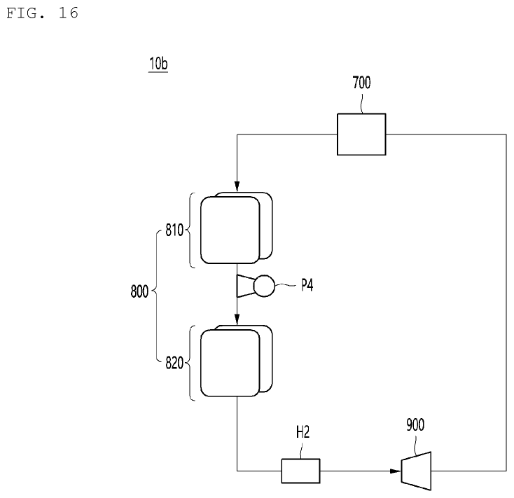

FIG. 15 illustratively shows the secondary loop 10b according to one embodiment of the invention.

Referring to FIG. 15, the secondary loop 10b according to one embodiment of the invention may include the 2-1^{th} heat exchange unit 700, the 2-1^{th} intermediate medium storage unit 800, the second power generation unit 900, the 2-2^{th} intermediate medium storage unit 1000, the second compression unit 1100, and the 2-2^{th} heat exchange unit 1200.

The secondary loop 10b in this embodiment includes the same components as the secondary loop 10b in the eighth embodiment, but the 2-1^{th} intermediate medium storage unit 800 may include a primary storage unit 810 and a secondary storage unit 820.

Specifically, the 2-1^{th} intermediate medium storage unit 800 according to one embodiment of the invention may include a primary storage unit 810 configured to compress and store the second intermediate medium for which the 2-1^{th} heat exchange has occurred in the 2-1^{th} heat exchange unit 700 at a first pressure, and a secondary storage unit 820 configured to further compress and store the second intermediate medium compressed at the first pressure in the primary storage unit 810 at a second pressure. Here, according to one embodiment of the invention, the second pressure for compressing the second intermediate medium in the secondary storage unit 820 may be higher than the first pressure for compressing the second intermediate medium in the primary storage unit 810. According to one embodiment of the invention, the second intermediate medium may be moved from the primary storage unit 810 to the secondary storage unit 820 by operation of a pump P4. According to one embodiment of the invention, the process after the second intermediate medium has been stored in the secondary storage unit 820 (or the 2-1^{th} intermediate medium storage unit 800) is the same as the eighth embodiment, and thus will be omitted.

### Twelfth Embodiment

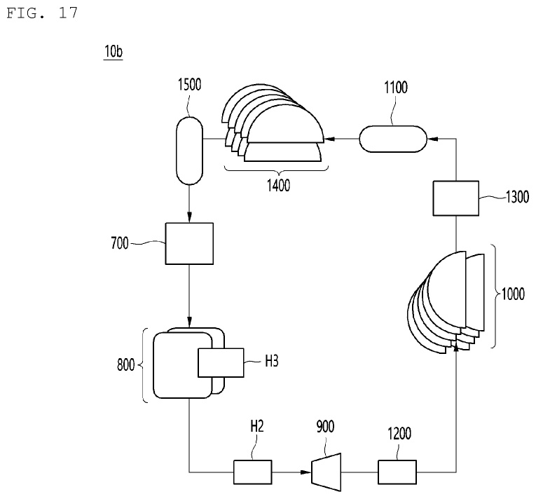

FIG. 16 illustratively shows the secondary loop 10b according to one embodiment of the invention.

Referring to FIG. 16, the secondary loop 10b according to one embodiment of the invention may include the 2-1^{th} heat exchange unit 700, the 2-1^{th} intermediate medium storage unit 800, and the second power generation unit 900.

The secondary loop 10b in this embodiment includes the same components as the secondary loop 10b in the sixth embodiment, but the 2-1^{th} intermediate medium storage unit 800 may include a primary storage unit 810 and a secondary storage unit 820.

Specifically, the 2-1^{th} intermediate medium storage unit 800 according to one embodiment of the invention may include a primary storage unit 810 configured to compress and store the second intermediate medium for which the 2-1^{th} heat exchange has occurred in the 2-1^{th} heat exchange unit 700 at a first pressure, and a secondary storage unit 820 configured to further compress and store the second intermediate medium compressed at the first pressure in the primary storage unit 810 at a second pressure. Here, according to one embodiment of the invention, the second pressure for compressing the second intermediate medium in the secondary storage unit 820 may be higher than the first pressure for compressing the second intermediate medium in the primary storage unit 810. According to one embodiment of the invention, the second intermediate medium may be moved from the primary storage unit 810 to the secondary storage unit 820 by operation of the pump P4. According to one embodiment of the invention, the process after the second intermediate medium has been stored in the secondary storage unit 820 (or the 2-1^{th} intermediate medium storage unit 800) is the same as the sixth embodiment, and thus will be omitted.

### Thirteenth Embodiment

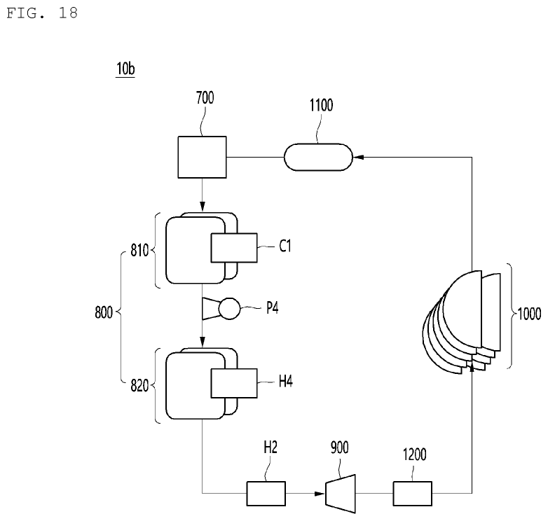

FIG. 17 illustratively shows the secondary loop 10b according to one embodiment of the invention.

Referring to FIG. 17, the secondary loop 10b according to one embodiment of the invention may include the 2-1^{th} heat exchange unit 700, the 2-1^{th} intermediate medium storage unit 800, the second power generation unit 900, the 2-2^{th} intermediate medium storage unit 1000, the second compression unit 1100, the 2-2^{th} heat exchange unit 1200, the 2-3^{th} heat exchange unit 1300, a 2-3^{th} intermediate medium storage unit 1400, and a third compression unit 1500.

The secondary loop 10b in this embodiment may correspond to the secondary loop 10b in the tenth embodiment where the 2-3^{th} intermediate medium storage unit 1400 and the third compression unit 1500 are additionally disposed between the second compression unit 1100 and the 2-1^{th} heat exchange unit 700.

According to one embodiment of the invention, the second intermediate medium compressed in the second compression unit 1100 may be stored in a gaseous state in the 2-3^{th} intermediate medium storage unit 1400. The second intermediate medium moving out of t intermediate medium storage unit 1400 may be liquefied while passing through the third compression unit 1500 (which may function to compress the second intermediate medium) and the 2-1^{th} heat exchange unit 700 (which may cause the 2-1^{th} heat exchange to occur between the second intermediate medium and the first intermediate medium). Further, according to one embodiment of the invention, the second intermediate medium liquefied through the third compression unit 1500 and the 2-1^{th} heat exchange unit 700 may be stored in the 2-1^{th} intermediate medium storage unit 800, wherein the second intermediate medium may be supplied with heat from a heat source H3 while stored in the 2-1^{th} intermediate medium storage unit 800. According to one embodiment of the invention, the heat supplied from the heat source H3 may be utilized to increase the temperature of the second intermediate medium stored in the 2-1^{th} intermediate medium storage unit 800. According to one embodiment of the invention, the process after the second intermediate medium has been stored in the 2-1^{th} intermediate medium storage unit 800 is the same as the tenth embodiment, and thus will be omitted.

### Fourteenth Embodiment

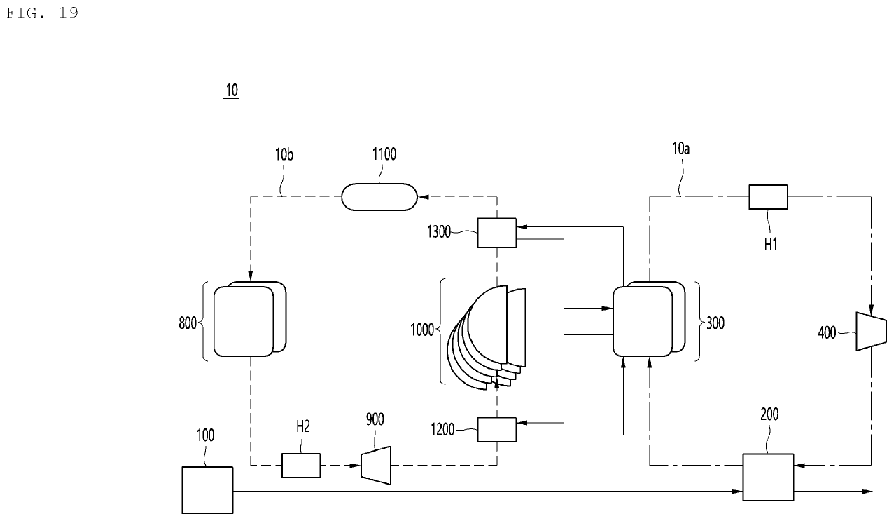

FIG. 18 illustratively shows the secondary loop 10b according to one embodiment of the invention.

Referring to FIG. 18, the secondary loop 10b according to one embodiment of the invention may include the 2-1^{th} heat exchange unit 700, the 2-1^{th} intermediate medium storage unit 800, the second power generation unit 900, the 2-2^{th} intermediate medium storage unit 1000, the second compression unit 1100, and the 2-2^{th} heat exchange unit 1200.

The secondary loop 10b in this embodiment includes the same components as the secondary loop 10b in the eleventh embodiment, but may be configured such that the second intermediate medium may be supplied with cold energy from a cold energy source C1 while stored in the primary storage unit 810, or supplied with heat from a heat source H4 while stored in the secondary storage unit 820.

Specifically, according to one embodiment of the invention, the second intermediate medium for which the 2-1^{th} heat exchange has occurred in the 2-1^{th} heat exchange unit 700 may be stored in the primary storage unit 810, and the second intermediate medium may be supplied with cold energy from the cold energy source C1 while stored in the primary storage unit 810. According to one embodiment of the invention, the cold energy supplied from the cold energy source C1 may be utilized to stabilize the primary storage unit 810. Further, according to one embodiment of the invention, the second intermediate medium moved to the secondary storage unit 820 by operation of the pump P4 may be stored in the secondary storage unit 820, and the second intermediate medium may be supplied with heat from the heat source H4 while stored in the secondary storage unit 820. According to one embodiment of the invention, the heat supplied from the heat source H4 may be utilized to increase the temperature of the second intermediate medium stored in the secondary storage unit 820. According to one embodiment of the invention, the process after the second intermediate medium has been stored in the secondary storage unit 820 (or the 2-1^{th} intermediate medium storage unit 800) is the same as the eleventh embodiment, and thus will be omitted.

Meanwhile, it is noted that as in this embodiment, the second intermediate medium may also be supplied with cold energy from a cold energy source (not shown) while stored in the primary storage unit 810, or supplied with heat from a heat source (not shown) while stored in the secondary storage unit 820 in the twelfth embodiment.

### Fifteenth Embodiment

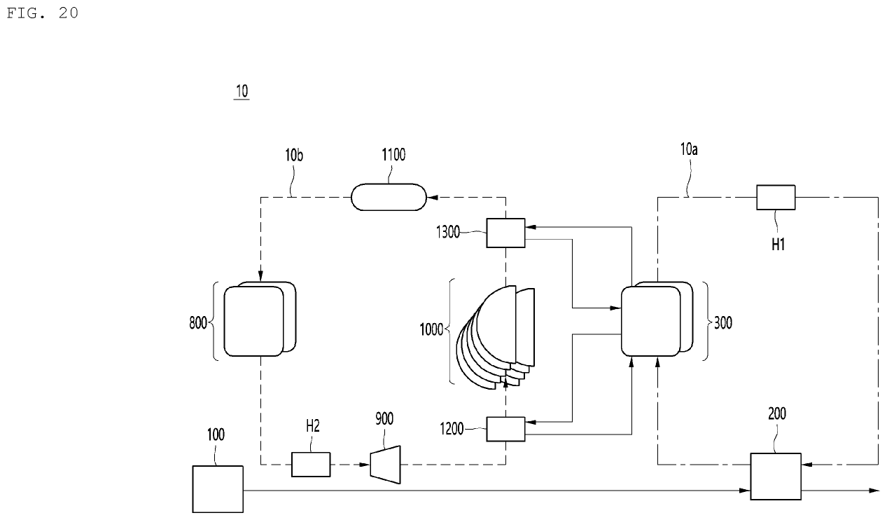

FIGS. 19 and 20 illustratively show the cold energy using system 10 including the secondary loop 10b according to one embodiment of the invention.

Referring to FIGS. 19 and 20, the secondary loop 10b in this embodiment may correspond to the secondary loop 10b in the tenth embodiment from which the 2-1^{th} heat exchange unit 700 is excluded. Specifically, according to the secondary loop 10b in this embodiment, the 2-1^{th} heat exchange unit 700 is excluded from the secondary loop 10b in the tenth embodiment, such that the 2-2^{th} heat exchange unit 1200 and the 2-3^{th} heat exchange unit 1300 which are respectively disposed at both ends of the 2-2^{th} intermediate medium storage unit 1000 may cause the primary loop 10a and the secondary loop 10b to interwork with each other, and the second intermediate medium liquefied through the second compression unit 1100 may be stored directly in the 2-1^{th} intermediate medium storage unit 800.

Meanwhile, as shown in FIG. 20, the first power generation unit 400 may be excluded from the primary loop 10a, in which case the process of generating electrical energy using the intermediate medium for which the 1-2^{th} heat exchange with the heat source H1 has occurred is omitted, but the cold energy using system 10 may operate normally.

Although the present invention has been described above in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

1. A system using cold energy, the system comprising:
a liquefied gas storage unit configured to store a liquefied gas;
a primary loop configured to circulate a first intermediate medium to which cold energy of the liquefied gas has been transferred; and
a secondary loop configured to circulate a second intermediate medium for which a heat exchange with the first intermediate medium has occurred in at least one heat exchange unit interworking with the primary loop,
wherein the primary loop comprises:
a first heat exchange unit configured to cause the cold energy of the liquefied gas to be transferred to the first intermediate medium so that a 1-1^{th} heat exchange occurs between the liquefied gas and the first intermediate medium; and
a first intermediate medium storage unit configured to store the first intermediate medium for which the 1-1^{th} heat exchange has occurred, and capable of being switched from a closed state to an open state or from an open state to a closed state, and
wherein the at least one heat exchange unit causes a heat exchange to occur between the first intermediate medium and the second intermediate medium in a state in which the first intermediate medium is stored in the first intermediate medium storage unit.

2. The system of claim 1, wherein the secondary loop comprises:
a 2-1^{th} heat exchange unit configured to cause a 2-1^{th} heat exchange to occur between the second intermediate medium and the first intermediate medium;
a 2-1^{th} intermediate medium storage unit configured to store the second intermediate medium for which the 2-1^{th} heat exchange has occurred; and
a second power generation unit configured to generate electrical energy using the second intermediate medium for which a 2-2^{th} heat exchange with a heat source has occurred.

3. The system of claim 2, wherein the secondary loop further comprises:
a 2-2^{th} intermediate medium storage unit configured to store the second intermediate medium used to generate the electrical energy; and
a second compression unit configured to compress the second intermediate medium moving out of the 2-2^{th} intermediate medium storage unit.

4. The system of claim 3, wherein the secondary loop further comprises:
a 2-2^{th} heat exchange unit configured to, before the second intermediate medium used to generate the electrical energy is stored in the 2-2^{th} intermediate medium storage unit, cause a 2-3^{th} heat exchange to occur between the second intermediate medium and the first intermediate medium.

5. The system of claim 4, wherein the secondary loop further comprises:
a bypass configured to cause the second intermediate medium moving out of the 2-2^{th} intermediate medium storage unit not to pass through the second compression unit, and
wherein the bypass is formed in parallel with a path in which the second compression unit is disposed.

6. The system of claim 4, wherein the secondary loop further comprises:
a 2-3^{th} heat exchange unit configured to, before the second intermediate medium is compressed in the second compression unit, cause a 2-4^{th} heat exchange to occur between the second intermediate medium and the first intermediate medium.

7. The system of claim 2, wherein the 2-1^{th} intermediate medium storage unit comprises a primary storage unit configured to compress and store the second intermediate medium for which the 2-1^{th} heat exchange has occurred at a first pressure, and a secondary storage unit configured to further compress and store the second intermediate medium compressed at the first pressure at a second pressure, and
wherein the second pressure is higher than the first pressure.

8. The system of claim 6, wherein the secondary loop further comprises:
a 2-3^{th} intermediate medium storage unit configured to store the second intermediate medium compressed in the second compression unit; and
a third compression unit configured to compress the second intermediate medium moving out of the 2-3^{th} intermediate medium storage unit.

9. The system of claim 7, wherein the second intermediate medium is supplied with cold energy from a cold energy source while stored in the primary storage unit, and supplied with heat from a heat source while stored in the secondary storage unit.
